(19) United States
(12) Patent Application Publication
(10) Pub. No.: US 2019/0176383 A1
(43) Pub. Date: Jun. 13, 2019

(54) PREDICTIVE SIMULATION SYSTEM AND METHOD FOR INJECTION MOLDING

(71) Applicant: RJG, Inc., Traverse City, MI (US)

(72) Inventor: Kuang-Yi Lu, Traverse City, MI (US)

(73) Assignee: RJG, Inc., Traverse City, MI (US)

(21) Appl. No.: 16/209,135

(22) Filed: Dec. 4, 2018

Related U.S. Application Data
(60) Provisional application No. 62/595,705, filed on Dec. 7, 2017.

(51) Int. Cl. B29C 45/76; B29C 45/77; G06F 17/50; G06T 17/20

(52) U.S. Cl. CPC B29C 45/7693; B29C 45/762; G06F 2217/41; G06F 17/5018; G06T 17/20; B29C 45/77

(57) ABSTRACT

An exemplary method for simulating an injection molding process may include first generating a mesh model of a structure, and generating a mesh model of an injection unit molding machine, including at least a screw tip of the injection unit. The method may then include providing the ability to specify a material to be injected into the structure, configuring parameters in different zones of at least the injection unit, combining the mesh models of the structure and the injection unit, and providing the ability to apply at least one of a velocity and a pressure profile of the screw tip. The method may then include running a simulated operation of the combined mesh models of the injection unit and the structure.

### CROSS-REFERENCE TO RELATED APPLICATION

This application claims priority to U.S. Provisional Application No. 62/595,705 filed Dec. 7, 2017 and hereby incorporated by reference in its entirety.

### FIELD OF TECHNOLOGY

The present disclosure pertains to a predictive simulation system and method for an injection molding process.

### BACKGROUND

Injection molding is a common manufacturing process in which a material, including, but not limited to, thermoplastic, thermoset, or elastomer material, is injected into a mold. A typical injection molding system includes an injection unit, a mold, and a clamp unit, where the injection unit injects the material under certain parameters and conditions into the mold, during which the clamp unit holds the mold closed.

Simulation programs have been developed to simulate the injection molding process so that molds, injection parameters, and the like could be optimized prior to actually injection molding parts in mass to ensure higher quality and consistency of the parts. Such simulation programs have focused primarily on modeling the mold only. As a consequence, injection pressure has not been able to be consistently predicted, as it is named as “pressure loss” or “sprue pressure”, and therefore, discrepancies between prediction and actual molded parts such as cavity pressure, part dimension, clamp force requirement, etc. can be observed.

Accordingly, an improved system and method is presented that more effectively simulates an injection molding process to minimize discrepancies during injection molding processes and avoid any defects in the resulting products.

### BRIEF DESCRIPTION OF THE DRAWINGS

Referring now to the drawings, illustrative embodiments are shown in detail. Although the drawings represent some embodiments, the drawings are not necessarily to scale and certain features may be exaggerated, removed, or partially sectioned to better illustrate and explain the present disclosure. Further, the embodiments set forth herein are not intended to be exhaustive or otherwise limit or restrict the claims to the precise forms and configurations shown in the drawings and disclosed in the following detailed description.

FIG. 1 is a schematic system and data flow diagram of an exemplary simulation system and the data exchange therein;

FIG. 2 is a schematic diagram of the force and pressure distribution of an injection molding machine of the simulation system of FIG. 1;

FIG. 3 is a schematic flow diagram of an exemplary method for using the simulation system of FIG. 1 to accurately obtain variables to use in a real-time injection molding process;

FIG. 4 is a schematic flow diagram of an exemplary simulation method for simulating the injection molding process;

FIG. 5A is an exemplary mesh domain of a mold structure generated during the simulation method of FIG. 4;

FIG. 5B is an exemplary mesh domain of an air cavity structure generated during the simulation method of FIG. 4;

FIGS. 6A-6C are graphic illustrations of a progression of the simulation method;

FIGS. 7A and 7B are graphical comparisons of injection pressure and cavity pressure as functions of time resulting from the simulation of FIG. 3, an existing simulation approach, and an actual injection molding output;

FIG. 8 is an exemplary graph of predictive data that is output by the system of FIG. 1;

FIG. 9 is a graphical comparison of the predictive data from FIG. 8 with actual measured data; and

FIGS. 10 and 11 are exemplary graphs of predictive data that is output by the system of FIG. 1.

### DETAILED DESCRIPTION

Methods, systems, and apparatus, including computer programs encoded to perform calculation, predict the requirement of key injection molding machine specification, confidence of mold cavity fill and progression, molding machine-dependent process parameters and potential molding issues without the need of any prior measurement data or trial operation for the simulation inputs. The method proceeds to mesh and connect both the injection mold and machine component dimensions, including, but not limited to, the injection unit configuration and its process parameters. The method may simulate the screw/plunger dynamic movement and calculate the melt transfer from the injection unit, or hot runner if applicable to the mold cavity. With this method, the process compatibility of mold and machine can be assessed more precisely and process development can be optimized and completed prior to the tool tryouts.

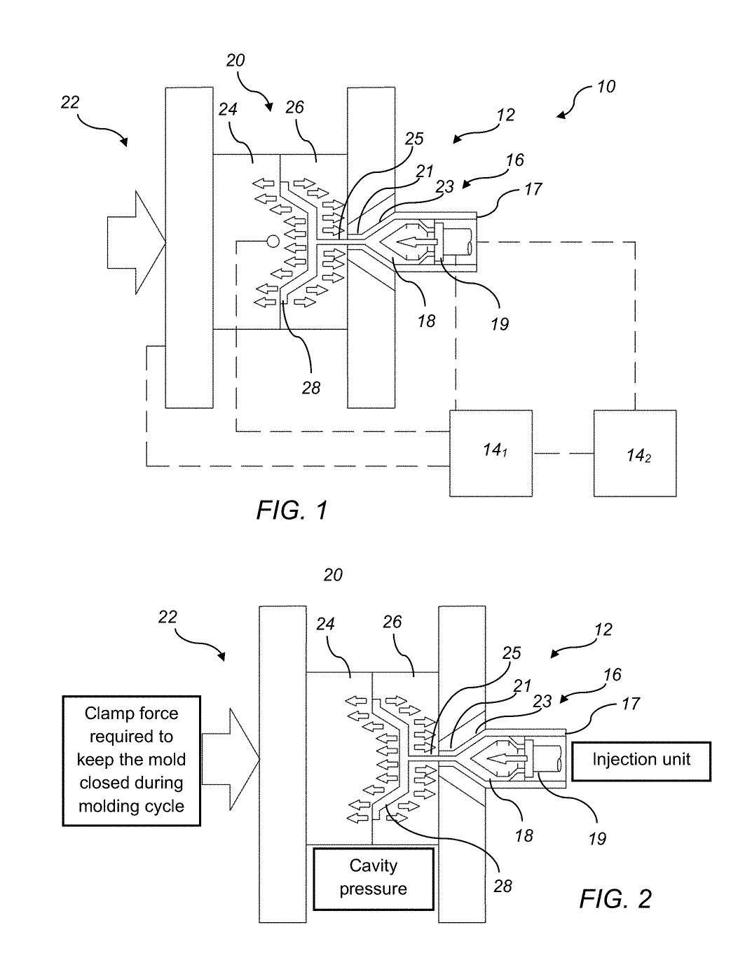

Referring now to the figures, FIG. 1 illustrates an exemplary system 10 that may be utilized to perform predictive simulations of an injection molding process. The system 10 generally may include an injection molding machine 12 and computing devices 14₁ and 14₂. The computing devices 14₁ and 14₂ may be used to run simulations of injection molding processes, predict, acquire and process data, store data, and the like. It should be appreciated that a single computing device may be used to perform all the functions of computing devices 14₁ and 14₂. The system 10 may also include one or more data stores (not shown) that may store such data as machine parameters, historical outputs, and the like. It should be appreciated that a data store may be internal to any one of the computing device 14₁ and 14₂ and the injection molding machine, may be external and/or remotely located. The injection molding machine 12 and the computing devices 14₁ and 14₂ may communicate with each other over a communications network. Such a communications network may include, but is not limited to any combination of, Ethernet, Bluetooth, Wi-Fi, Wi-Fi protocols (802.11b, 802.11g, 802.11n, etc.), 3G, 4G, 5G, LTE, or any other wired or wireless communications mechanisms. The injection molding machine 12 may also include a controller or other computing device (not shown) that may communicate with the computing devices 14₁ and 14₂ over the communications network.

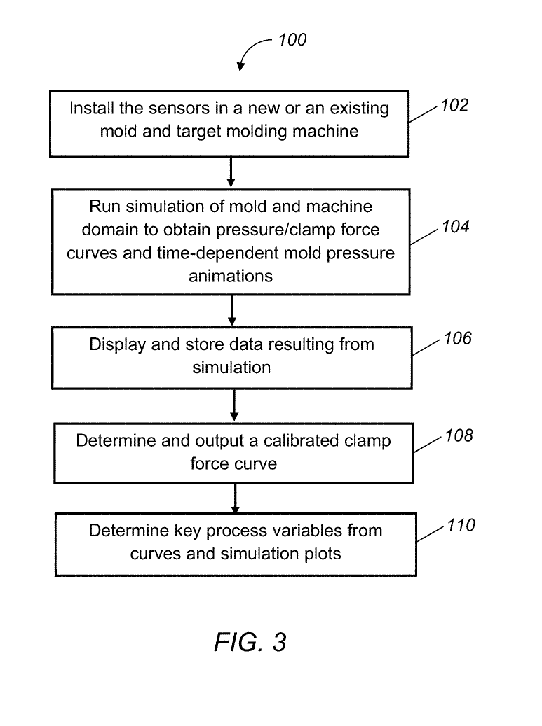

The injection molding machine 12 may include an injection unit 16 at which a material 18 may be injected into an injection mold 20, and a clamp unit 22 configured to keep the injection mold 20 closed during the injection molding process. As seen in FIGS. 1 and 2, the injection unit 16 generally may have a barrel 17 with a screw or plunger 19 positioned therein to deliver the material 18 through a nozzle 21 into the injection mold 20. The injection unit 16 may include an end cap 23 connecting the barrel 17 with the nozzle 21. The injection mold 20 in turn may include mold halves 24 and 26 that together define one or more mold cavities 28. The injection mold 20 may also include one or more runners 25 into which the material 18 enters from the nozzle 21 and into the one or more cavities 28. It should be appreciated the mold cavity 28 may have any defined shaped. It should further be appreciated that there may be multiple mold cavities formed in one mold configuration.

The injection molding machine 10 may implement various sensors located at different locations within the injection unit 16, the injection mold 20, and/or the clamp unit 22, and may be configured to measure different measurements at each location. The sensors may include, but are not limited to, a stroke sensor for measuring the position and/or speed of the screw, a pressure sensor in the mold cavity 28 for measuring pressure within the mold cavity 28 while the material 18 is being injected therein, temperature sensors, and a proximity sensor configured to detect whether the mold 20 is open or closed. The sensors may be in communication with one or more of the computing devices 14₁ and 14₂ and a controller of the injection molding machine 12 if it is equipped with one, for example, over the communications network, to provide data to be processed and/or stored.

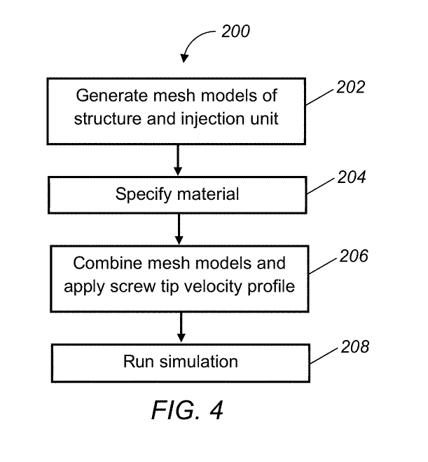

Referring now to FIG. 3, an exemplary method 100 for using system 10 to accurately determine variables to use in a real-time injection molding process is shown. Method 100 may begin at step 102 in which sensors may be installed in a mold, which may be a new or an existing mold, and in a target injection molding machine. At step 104, a simulation of the target injection molding machine and mold may be run, for example, via computing device 14₂, to obtain forecasted process condition, pressure and clamp force curves, and time-dependent pressure/temperature animations of the simulation objects. The simulation may be performed according to method 200 illustrated in FIG. 4 and described below.

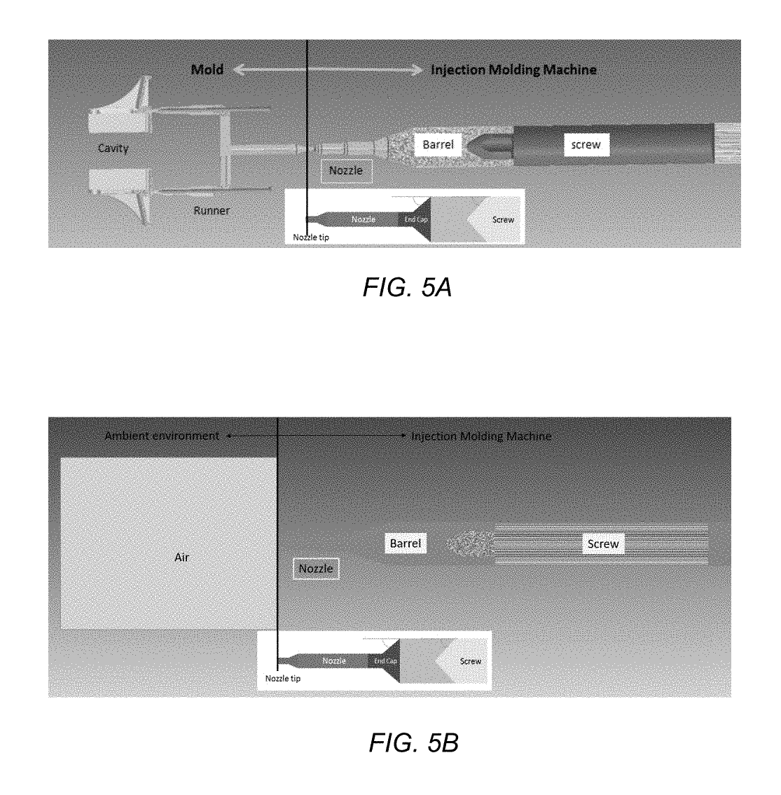

Referring now to FIG. 4, an exemplary simulation method 200 is illustrated. The simulation method 200 may begin at step 202 in which a mesh model of a structure to be injected may be generated. The structure may be of the mold cavity defined by the mold 20, which may include a runner system (one or more runners) and mold cavity(ies), or alternatively, an air cavity. Where the structure is an air cavity, a pressure predicted as an air shot pressure for the injection molding machine may be used. At step 204, a mesh model of the injection unit may then be generated. The mesh model may include, but is not limited to, at least the screw, including the screw diameter, the screw tip and its profile in three zones, non-return valve mechanism, barrel size and diameter, end cap design, and nozzle design and configurations. Exemplary meshes are illustrated in FIGS. 5A (with the mold) and 5B (with the air cavity).

The surface mesh of the screw tip may indicate the stroke position or shot volume in the molding process. The tip contour may be used as a moving boundary to push the melt volume (material) toward the structure. The movement of the boundary may embody movement of the screw in the injection molding process, which may be controlled either in a speed or pressure setting of injection unit or external signals such as cavity pressure.

At step 206, the material may be specified, and the melt and ambient temperatures of each zone of the injection unit and the structure may be configured. Where the structure is a mold, zones may include the hot runner system, if applicable. At step 208, the mesh models of both the structure (mold cavity or air cavity) and the injection unit domains may be combined, and velocity and pressure profile of the screw tip may be applied. At step 210, the simulation may be run. When the molding machine is in a velocity control phase, compression force is required to transfer the melt ahead of the screw into the structure. The injection pressure, as an output of the molding machine to move the screw is predicted by the resultant force by the cross-sectional area of the screw. When the molding machine is in a pressure control phase, the applied pressure of the molding machine is equivalent to the force divided by the cross-sectional area of the screw according to the following formula:

F(t)=P(t)XA

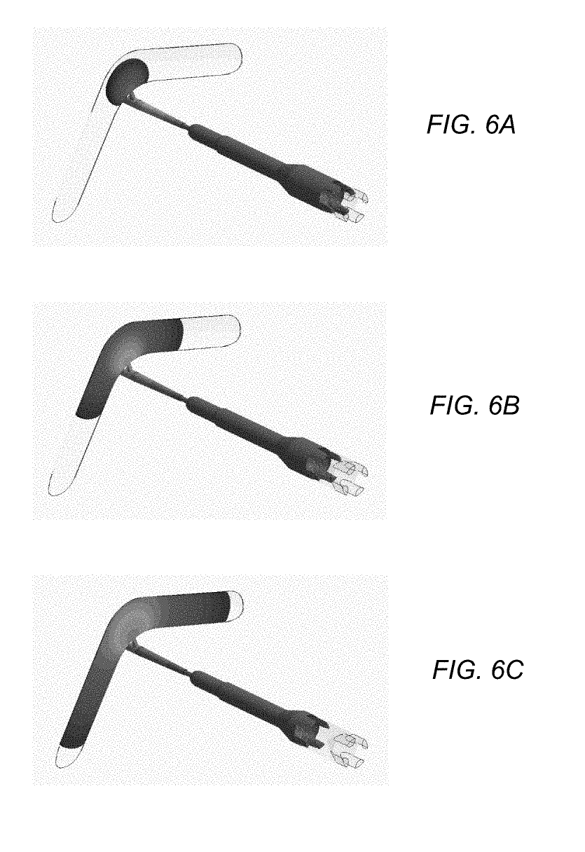

The simulation method may determine the history of physical fields of both injection unit and mold cavity domain throughout the molding process, including the pressure, temperature, velocity, shear rate, particle movement, viscosity, filler orientation/percentage and density. The reciprocating movement of the screw may then be modeled to determine the melt behavior of the material in both the structure and the injection molding machine, as illustrated in FIGS. 6A-6C.

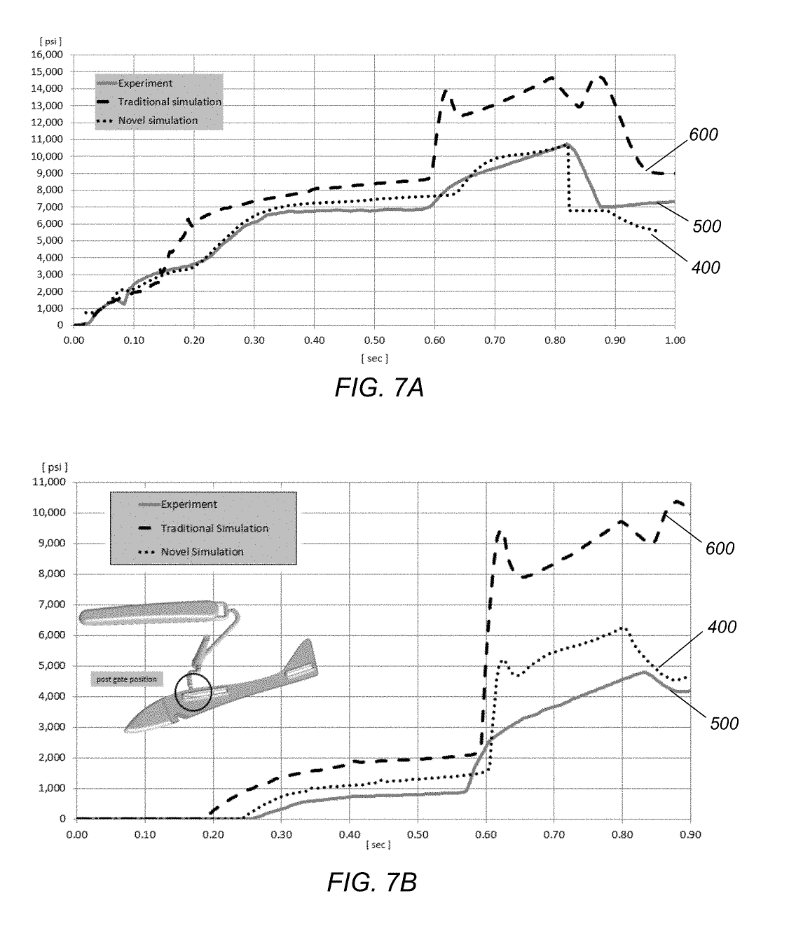

The inclusion of the injection unit in the mesh model results in more accuracy as illustrated in FIGS. 7A and 7B, which graphically illustrate the injection pressure and cavity pressure as functions of time, respectively. In FIG. 7A, the simulation with the injection unit model exhibits a much similar waveform of injection pressure curve comparing to the simulation with only the mold domain. In FIG. 7B, the curve 400 resulting from the simulation method 200 is closer to the curve 500 actually measured by cavity pressure sensor than the curve 600 of a simulation method only modeling the mold. In particular, the pressure magnitude and melt front arrival time is much closer, as the simulation with the injection unit model numerically calculates the compressibility of the melt in the injection unit.

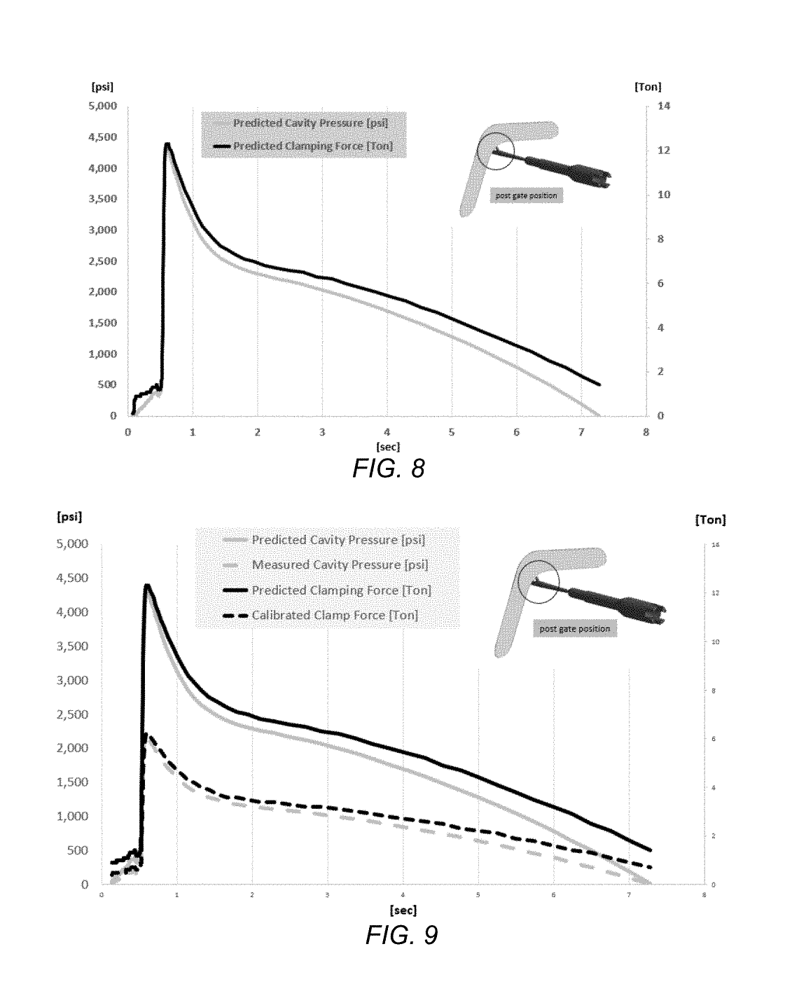

Referring back to FIG. 3 and method 100, at step 106, the data acquisition system (e.g., computing device 14₁) may display and store the data resulting from the simulation method 200. The data may be in the form of curves, which may include, but are not limited to, a curve of stroke position versus time, a predicted plastics injection pressure curve, a predicted cavity pressure history curve, a mold temperature history curve, a plastics temperature curve, and a nozzle pressure curve. The mold temperature curves may be for metal or plastic. FIG. 8 illustrates an exemplary predicted flow front pattern and pressure distribution of the mold cavity, predicted post gate pressure curve and corresponding clamp force plot history by simulation that may be displayed at step 106.

a curve of stroke position versus time as a machine process template;

a predicted plastics injection pressure curve as a machine process template;

a predicted cavity pressure history curve as a machine process template;

a mold temperature history curve as a machine process template;

a plastics temperature curve as a machine process template; and

a nozzle pressure curve as a machine process template.

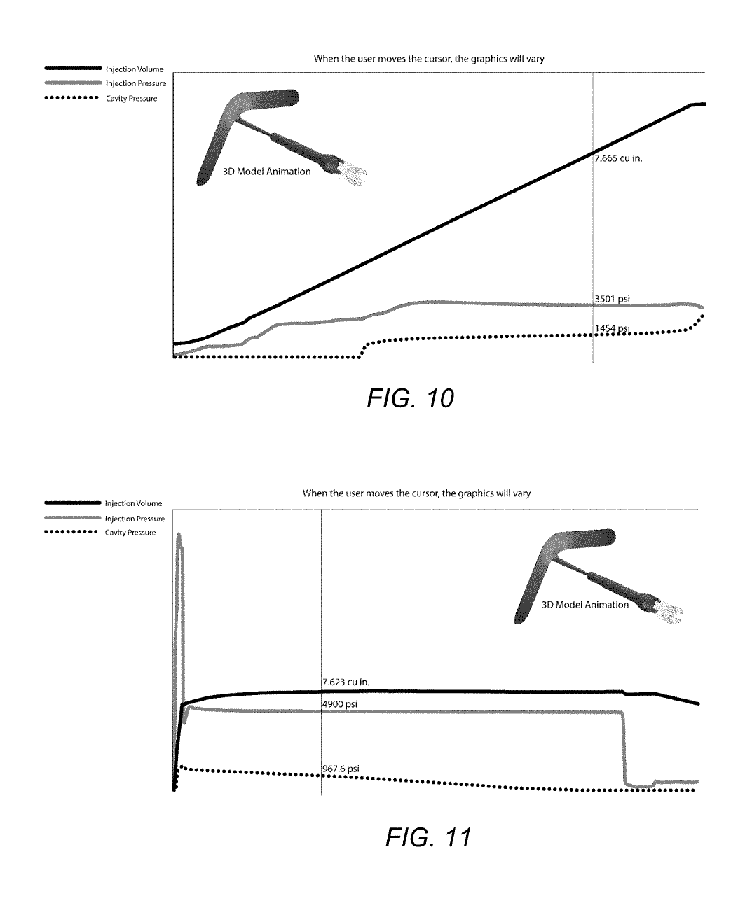

At step 108, a calibrated clamp force curve may be determined and outputted, for example on the computing device 14₁, when taking into consideration predicted pressure, as determined from the simulation method 200, and measured pressure as measured by a cavity pressure sensor. As an exemplary output, FIG. 9 illustrates the calibrated clamp force compared to the predicted clamping force. FIG. 10 illustrates a calibrated clamp force display with a flow front progression cavity pressure. The rendered flow front model may be displayed as a static display or as a dynamic display that illustrates different filling percentage/pressure distribution at different time and stroke positions. By moving a cursor, the fill percentage of the model display may change in the system. FIG. 11 illustrates a calibrated clamp force display along with cavity pressure distribution after the mold cavity is filled. By moving the cursor in the plot on the X-axis (time), the cavity pressure plot may change. Changes in the injection speed, pack/hold pressure, and/or the material may also change the pressure measurement, though the sensor reading and clamp force will maintain the similar wave form.

At step 110, tool operators, e.g., molders, may follow the curves and simulation plots to determine key process variables for real-time injection molding. For example, the predicted plastics pressure curve can be saved in a digital format to display on the machine panel or external process monitoring devices for the molders to use as machine process template to set up the process parameter accordingly. Similarly, the predicted cavity pressure history curves can be saved in a digital format to display on the machine panel or external process monitoring devices for the molders to use as a cavity pressure template to match the cavity pressure curves if the mold is instrumented with sensors. Further, predicted clamp force history may be used to estimate clamp tonnage requirement in various process conditions to prevent molding issues. The curves can be output on the machine panel or external process monitoring devices for molders to set adequate clamp force. When the mold is transferred to other molding machines with different screw size and clamp tonnage capacity, the injection unit may be remodeled in the simulation domain via method 200, and the capability and machine-dependent process parameters may be evaluated accordingly. It should be appreciated that all the curves generated, for example, in step 106, can be saved as machine process templates for use by molders.

As described above and illustrated in the figures, the system 10 and method 100 allow for a more realistic flow rate to be predicted as it is associated with and accounts for the screw movement and compressibility of the melt in the injection unit and hot runner system if applicable. As illustrated in FIGS. 7A and 7B, the injection pressure and cavity pressure prediction in both magnitude and waveform are more sensitive in the traditional molding simulation (i.e., without injection unit model), while the system 10 and method 100 result in both waveform and magnitude being closer to the data actually collected from the injection molding machine via sensors.

In general, computing systems and/or devices, such as the computing devices 14₁ and 14₂, may include at least one memory and at least one processor. Moreover, they may employ any of a number of computer operating systems, including, but not limited to, versions and/or varieties of the Microsoft Windows® operating system, the Unix operating system (e.g., the Solaris® operating system distributed by Oracle Corporation of Redwood Shores, Calif.), CentOS, the AIX UNIX operating system distributed by International Business Machines of Armonk, N.Y., the Linux operating system, the Mac OS X and iOS operating systems distributed by Apple Inc. of Cupertino, Calif., the BlackBerry OS distributed by Research In Motion of Waterloo, Canada, and the Android operating system developed by the Open Handset Alliance. Examples of computing devices include, without limitation, a computer workstation, a server, a desktop, a notebook, a laptop, a handheld computer, a smartphone, a tablet, or some other computing system and/or device.

Such computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, C#, Objective C, Visual Basic, Java Script, Perl, Tomcat, representational state transfer (REST), etc. In general, the processor (e.g., a microprocessor) receives instructions, e.g., from the memory, a computer-readable medium, etc., and executes these instructions, thereby performing one or more processes including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instruction) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including, but not limited to, coaxial cables, copper wire, and fiber optics, including the wires that comprise a system bus coupled to a processor of a computer. Common forms of computer-readable media include, for example, a floppy disk, a flexible disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein. Alternatively, the application software product may be provided as hardware or firmware, or combinations of software, hardware, and/or firmware.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

It will be appreciated that the aforementioned method and devices may be modified to have some components and steps removed, or may have additional components and steps added, all of which are deemed to be within the spirit of the present disclosure. Even though the present disclosure has been described in detail with reference to specific embodiments, it will be appreciated that the various modifications and changes can be made to these embodiments without departing from the scope of the present disclosure as set forth in the claims. The specification and the drawings are to be regarded as an illustrative thought instead of merely restrictive thought.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A method for simulating an injection molding process, comprising:
generating a mesh model of a structure;
generating a mesh model of an injection unit of an injection molding machine, including at least a screw tip of the injection unit;
providing the ability to specify a material to be injected into the structure;
configuring parameters in different zones of at least the injection unit;
combining the mesh models of the structure and the injection unit;
providing the ability to apply at least one of a velocity and a pressure profile of the screw tip; and
running a simulated operation of the combined mesh models of the injection unit and the structure.

2. The method of claim 1, wherein the structure is a mold cavity defined by a mold of an injection molding system.

3. The method of claim 1, wherein the structure is an air cavity.

4. The method of claim 1, wherein the mesh model of the injection unit includes at least a screw tip and diameter, an end cap, and a nozzle of the injection unit.

5. The method of claim 1, wherein the parameters include at least a melt temperature at which the material is to be heated in each zone, and an ambient temperature.

6. The method of claim 1, further comprising outputting a curve of stroke position versus time as a machine process template.

7. The method of claim 1, further comprising outputting at least one of a predicted plastics injection pressure curve, a predicted cavity pressure history curve, and a mold temperature history curve.

8. The method of claim 7, further comprising saving the predicted plastics injection pressure curve as a machine process template.

9. The method of claim 7, further comprising outputting the predicted cavity pressure history curve as a mold process matching template.

10. The method of claim 7, further comprising outputting the mold temperature history curve as a mold process matching template.

11. The method of claim 3, further comprising using a pressure predicted as an air shot pressure for the injection molding machine.

12. The method of claim 1, further comprising displaying prediction results on a display of the computing device of the simulated operation as a static display or a dynamic display.

13. A system comprising:
an injection molding machine including an injection unit having at least a screw;
at least one computing device configured to:
generate a mesh model of a structure;
generate a mesh model of the injection unit, including at least the screw;
receive a specification of the material to be injected into the structure;
receive a configuration of parameters in different zones of at least one of the injection unit and the structure;
combine the mesh models of the structure and the injection unit;
provide the ability to apply at least one of a velocity profile and a pressure profile of the screw tip; and
run a simulated operation of the combined mesh models of the injection unit and the structure.

14. The system of claim 13, wherein the structure is a mold cavity defined by a mold of an injection molding system.

15. The system of claim 14, wherein the mesh model of the injection unit includes at least a screw tip and diameter, an end cap, and a nozzle of the injection unit.

16. The system of claim 13, wherein the structure is an air cavity.

17. The system of claim 13, wherein the parameters include at least a melt temperature at which the material is to be heated in each zone, and an ambient temperature.

18. The system of claim 13, wherein the computing device is configured to output at least one of:
a curve of stroke position versus time as a machine process template;
a predicted plastics injection pressure curve as a machine process template;
a predicted cavity pressure history curve as a machine process template;
a mold temperature history curve as a machine process template;
a plastics temperature curve as a machine process template; and
a nozzle pressure curve as a machine process template.

19. A non-transitory computer readable medium tangibly embodying computer-executable instructions that when executed by a processor cause the processor to perform operations comprising:
generating a mesh model of a structure;
generating a mesh model of an injection unit of an injection molding machine, including at least a screw tip of the injection unit;
providing the ability to specify a material to be injected into the structure;
configuring parameters in different zones of at least one of the injection unit and the structure;
combining the mesh models of the structure and the injection unit;
providing the ability to apply at least one of a velocity and a pressure profile of the screw tip; and
running a simulated operation of the combined mesh models of the injection unit and the structure.

20. The non-transitory computer readable medium of claim 19, wherein the structure is one of:
a mold cavity defined by a mold of an injection molding system; or
an air cavity.
